(19) United States
(12) Patent Application Publication
(10) Pub. No.: US 2016/0236662 A1
(43) Pub. Date: Aug. 18, 2016

(54) METHOD FOR OPERATING A BRAKING SYSTEM AND A BRAKING SYSTEM

(71) Applicant: CONTINENTAL TEVES AG & CO. OHG, Frankfurt (DE)

(72) Inventors: Andreas Neu, Kuhardt (DE); Thorsten Ullrich, Gernsheim (DE); Tobias Scheller, Hofbieber (DE); Robert Schmidt, Kelkheim (DE); Joachim Borneis, Darmstadt (DE); Benjamin Jüstel, Frankfurt (DE); Patrick Henke, Frankfurt (DE)

(21) Appl. No.: 15/025,329

(22) PCT Filed: Jul. 10, 2014
(86) PCT No.: PCT/EP2014/064878

§ 371 Date: Mar. 28, 2016

(30) Foreign Application Priority Data
Oct. 11, 2013 (DE) 10 2013 220 582.1

(51) Int. Cl. B60T 8/32

(52) U.S. Cl. CPC B60T 8/3275; B60T 2201/03; B60T 8/171

(57) ABSTRACT

A method for operating a brake system of a vehicle which includes a master brake cylinder which can be activated by the driver by a brake pedal, at least one driver-independent pressure source, at least one wheel brake to which a wheel speed sensor is assigned, and a brake activation sensor, wherein it is checked whether a hazardous situation is present, and in the case of a hazardous situation being detected the at least one driver-independent pressure source is activated. A hazardous situation is detected when the change in a measured deceleration over time or the absolute value of a measured deceleration exceeds a predefined hazard threshold value and a brake activation operation is detected. In addition, the invention relates to a brake system for a motor vehicle having brake assistance in hazardous situations which does not require a master brake cylinder pressure sensor.

### CROSS REFERENCE TO RELATED APPLICATIONS

This application is the U.S. National Phase Application of PCT International Application No. PCT/EP2014/064878, filed Jul. 10, 2014, which claims priority to German Patent Application No. 10 2013 220 582.1, filed Oct. 11, 2013, the contents of such applications being incorporated by reference herein.

### FIELD OF THE INVENTION

The invention relates to a method for operating a braking system of a vehicle and a braking system.

### BACKGROUND OF THE INVENTION

Systems that assist the brake actuation of the driver and that upon detecting a dangerous situation provide a rapid build-up of pressure up to the point where a braking slip control becomes active and the prevailing coefficient of friction is consequently used in an optimum manner are known under the term “brake assist system”. A dangerous situation is frequently detected by virtue of a rapid actuation of the brakes by the driver and this is expediently checked with reference to the gradient with respect to time of the pressure in the master brake cylinder. It is therefore necessary in the case of a brake assist system of this type, as is known for example from DE 101 37 016 A1, which is incorporated by reference, to provide a pressure sensor that is connected to the master brake cylinder. With a view to driving safety, it is absolutely necessary to avoid a brake assist system being activated in error (for example as a result of an invalid signal). Pressure sensors that are embodied in a redundant manner and prevent a brake assist system being activated in error are encumbered with high costs.

DE 10 2008 036 607 A1, which is incorporated by reference, discloses a method for boosting hydraulic brake pressure in a hydraulic brake system of a motor vehicle, wherein a first pressure component of a brake pressure is generated in the brake system in a manner controlled by the driver, which involves detecting a deceleration value that indicates the vehicle is decelerating and generating a second, additional pressure component in dependence upon the deceleration value. It is preferred that the second pressure component is generated in such a manner that it is essentially proportional to the first pressure component. In order to render it possible for an emergency braking situation to be detected in a redundant manner and consequently in a manner in which errors are prevented, plausibility checks are performed on a simple pressure sensor by means of comparing the measured pressure with a pressure value that is determined from the vehicle deceleration.

The document WO 2011/107301 A1, which is incorporated by reference, discloses a method for performing an emergency braking operation, in which a brake actuation that has been performed by the driver is boosted by a brake assist system, wherein the braking force boosting procedure is switched off in at least two stages. In the described method, an emergency situation that activates the brake assist system is detected preferably without a pressure sensor. This document does not disclose how it is possible without using a pressure sensor to reliably prevent the brake assist system being activated in error.

### SUMMARY OF THE INVENTION

An aspect of the present invention provides a method for operating a braking system or to provide a braking system that even without measuring the pressure in the master brake cylinder reliably assists the brake actuation of the driver and in particular avoids said brake assist system being activated in error.

A method is also provided for operating a braking system that comprises a master brake cylinder that can be actuated by the driver by means of a brake pedal, at least one driver-independent pressure source, at least one wheel brake that is allocated a wheel rotational speed sensor, and a brake actuation sensor, in particular a brake light switch, wherein a check is performed as to whether a dangerous situation is present and in the event that a dangerous situation is detected the at least one driver-independent pressure source is activated. In accordance with the invention, a dangerous situation is detected if the gradient with respect to time or the value of a measured deceleration exceeds a predetermined danger threshold value and a brake actuation is measured.

The actuation in error of the brake assist system is reliably prevented by virtue of the fact that a dangerous situation is detected with reference to the signals of at least two independent sensors: a first sensor for measuring a deceleration and a second sensor for detecting that the driver has actuated the brake. If the driver is driving by way of example up an incline and releases the accelerator pedal, the deceleration that occurs can be regarded in principle as a braking operation. However, as long as the brake pedal has not been actuated in this situation, it is not to be assumed that a dangerous situation is present. The method in accordance with the invention therefore prevents the vehicle from being fully braked without reason, such a full braking of the vehicle would pose a danger for the traffic following behind. If, on the other hand, it is to be assumed on the basis of plausible signals from the independent sensor that the driver has actuated the brake in panic or that a dangerous situation is present, then the driver is assisted by means of a build-up of hydraulic pressure. In the event of a dangerous situation, sufficient braking force is therefore provided in order to bring the vehicle to a stop in a short time. It is consequently assured that a brake assist system is reliably achieved without a pressure sensor being required in the brake circuit or braking system. It is preferred that the measured deceleration is determined from the signals at least from one wheel rotation speed sensor that is required for the brake slip control and a brake actuation is measured with the aid of the brake light switch. These sensors are cost-effective and are readily available owing to legal requirements (for example ECE R13H). The brake actuation sensor can be achieved as a switching element or as an analog or multi-step position sensor or can be arranged on the brake pedal or tandem master cylinder.

It is advantageous if the braking system comprises at least two, in particular four, wheel brakes that are each allocated a wheel rotational speed sensor, and if the measured acceleration is determined from the signals of at least two wheel rotational speed sensors. When using multiple sensors for measuring the deceleration, a mean value is formed in an expedient manner. As an alternative or in addition thereto, low-pass filtration is performed and/or the filtered wheel rotational speed signals are compared with the non-filtered wheel rotational speed signals. This facilitates the selection of suitable threshold values when making an adjustment to suit the respective vehicle or vehicle model in order to provide the quickest possible assistance in the event of a dangerous situation whilst maintaining a robustness with respect to false alerts. It is particularly advantageous to consider signals from wheel rotational speed sensors that are allocated to the front axle.

It is particularly advantageous if, in the presence of multiple wheel rotational speed sensors, a first deceleration is determined from the signals at least of a first wheel rotational speed sensor, and a second deceleration is determined from the signals at least from a second sensor, wherein a dangerous situation is only detected if both the gradient with respect to time or the value of the first deceleration and also the gradient with respect to time or the value of the second deceleration exceeds the predetermined danger threshold value. By way of example, it is possible to consider both a vehicle deceleration and also one or multiple wheel decelerations. By virtue of performing a plausibility check of this type on the wheel rotational speed signals, it is possible to select particularly low threshold values without increasing the risk of false alerts.

It is preferred that a dangerous situation is only detected if the gradient with respect to time or the value of the measured deceleration exceeds the predetermined danger threshold value within a predetermined period of time following the detection of a brake actuation. It is possible to perform a precise measurement of time by virtue of the fact that the brake actuation is detected with reference to a flank of the brake light switch signal from non-actuated to actuated or a comparison of the wheel rotational speed signal with a predetermined braking detection threshold value. By virtue of the fact that only the commencement of a braking operation is considered, it is possible to detect in a particularly reliable manner that the driver has actuated the brake in panic.

In accordance with one preferred embodiment of the invention, the signals of a gas pedal sensor are also taken into consideration, wherein the braking system is preconditioned and/or a dangerous situation is only detected if the release rate of the gas pedal exceeds a predetermined panic threshold value and/or the period of time between the gas pedal being released and the brake pedal being actuated is less than a predetermined reaction threshold value. Since a pedal sensor is often already used to detect that a driving pedal or rather a gas pedal has been actuated, this information can be simply evaluated. By virtue of taking into consideration in this manner the previous history, it is also possible in an expedient manner to initiate a procedure of preconditioning the braking system, wherein a start-up delay of the pump is reduced and/or by virtue of pre-filling the braking system it is possible without producing a significant magnitude of braking pressure to overcome the air gap if a rapid release of the gas pedal indicates to a dangerous situation.

In an expedient manner, a first solenoid valve is arranged between the master brake cylinder and wheel brakes and said first solenoid valve is in particular currentless open, wherein the driver-independent pressure source comprises an electric hydraulic pump that is connected on the outlet side to the wheel brake or wheel brakes and on the inlet side can be connected by way of a second solenoid valve, which is in particular currentless closed, to the master brake cylinder, and wherein a procedure of activating the driver-independent pressure source includes closing at least in part the first solenoid valve and opening the second solenoid valve. Braking systems comprising a vehicle dynamics control often comprise frequently in each brake circuit such solenoid valves and a hydraulic pump.

It is particularly expedient if the first solenoid valve can be controlled in an analog manner in order to maintain a predetermined pressure difference between the master brake cylinder and the wheel brakes, wherein the predetermined pressure difference between the master brake cylinder and the wheel brakes is limited to a constant value, preferably between 30 and 60 bar. By virtue of the fact that the first solenoid valve, in particular an isolation valve, opens if the pressure difference is exceeded and consequently the maximum pressure in the wheel brakes is limited, it is possible to omit the procedure of measuring the pressure in the wheel brakes. This excess current control of the isolation valve, wherein a predetermined pressure difference between the wheel brake and the master cylinder is set, makes it possible to superimpose the braking pressure that is built up by the driver with a pressure from the driver-independent pressure source. As a consequence, a braking behavior that is convincing with respect to driving comfort and safety is ensured.

In particular, the current is adjusted by means of the first solenoid valve according to a characteristic curve that describes the relationship between the valve current and the pressure difference and is preferably read out from a non-volatile storage device. By virtue of the fact that the current is adjusted with reference to a characteristic curve that has been expediently calibrated for the valve, it is possible to avoid any excessive deviations between the desired pressure difference and the pressure difference that is actually occurring.

It is advantageous if the procedure of measuring the deceleration is repeated and if an end of the dangerous situation is detected and the driver-independent pressure source is deactivated as soon as the value of the measured deceleration or the amount of increase in the measured deceleration after a predetermined period of time following the detection of the dangerous situation is less than a predetermined deactivation threshold value. By virtue of the fact that the increase in deceleration is observed at defined points in time, it is possible to detect for example a low coefficient of friction of the road surface. The braking assistance is not required at this point and can be terminated.

It is further advantageous if the procedure of measuring the deceleration is repeated, wherein an actual value of the deceleration is compared with a maximum value, wherein the actual value of the deceleration is stored as the new maximum value if the previous maximum value is less than the actual value of the deceleration, and that an end of the dangerous situation is detected and the driver-independent pressure source is deactivated if the actual value of the deceleration is less than a predetermined fraction of the maximum value. This renders it possible to detect that the driver is reducing his actuation of the brake, whereupon it is no longer necessary to provide braking assistance.

In an expedient manner, an end of the dangerous situation is detected and the driver-independent pressure source deactivated if the vehicle velocity is less than a predetermined stopping threshold value and/or an end of the brake actuation is measured and/or the driver-independent pressure source was operated for longer than a predetermined maximum time period. It is possible to terminate the braking assistance if the vehicle is stationary, the driver releases the brake pedal, or owing to the duration of the activation procedure it is assumed that the dangerous situation has ended.

An aspect of the invention also relates to a braking system for a motor vehicle and said braking system comprises a master brake cylinder that is actuated by the driver by means of a brake pedal, a driver-independent pressure source, in particular an electric hydraulic pump, at least one wheel brake that is allocated a wheel rotational speed sensor, and a brake actuation sensor, in particular a brake light switch. In accordance with the invention, the braking system is controlled by means of an electronic control unit that is connected to the brake actuation sensor and provides braking assistance in the event of a dangerous situation, but is not connected to a sensor for detecting the pressure in the master brake cylinder. It is also possible to provide that the brake light switch is embodied in a redundant manner in order to ensure that an actuation of the brake by the driver is detected in a fail-safe manner.

It is preferred that the electronic control unit comprises, in particular in each brake circuit, a first solenoid valve that is arranged between the master brake cylinder and the wheel brakes and is in particular currentless open, an electric hydraulic pump that is connected on the outlet side to the wheel brake or wheel brakes, a second solenoid valve by way of which the electric hydraulic pump can be connected on the inlet side to the master brake cylinder and which is in particular currentless closed, and also a control circuit for the first solenoid valve and the second solenoid valve, wherein in particular the control circuit for the first solenoid valve comprises means for controlling a desired current. This renders it possible to control an excess current of the isolation valve in order to superimpose a predetermined differential pressure onto the braking pressure generated by the driver.

It is preferred that the electronic control unit comprises a computing unit that performs a method in accordance with the invention, wherein in particular the program code for performing the method is stored in a non-volatile storage device.

It is preferred that the electronic control unit comprises an interface for a vehicle data bus and is connected in particular to an engine control unit. As a consequence, it is possible for example to also evaluate the signals of a gas pedal sensor so as to trigger the brake assist system.

### BRIEF DESCRIPTION OF THE DRAWINGS

Further preferred embodiments are evident in the subordinate claims and the description hereinunder of an exemplary embodiment with reference to the figures, in which:

FIG. 1 illustrates an exemplary braking system, and

FIG. 2 illustrates a schematic view of a braking operation.

### DETAILED DESCRIPTION OF THE PREFERRED EMBODIMENTS

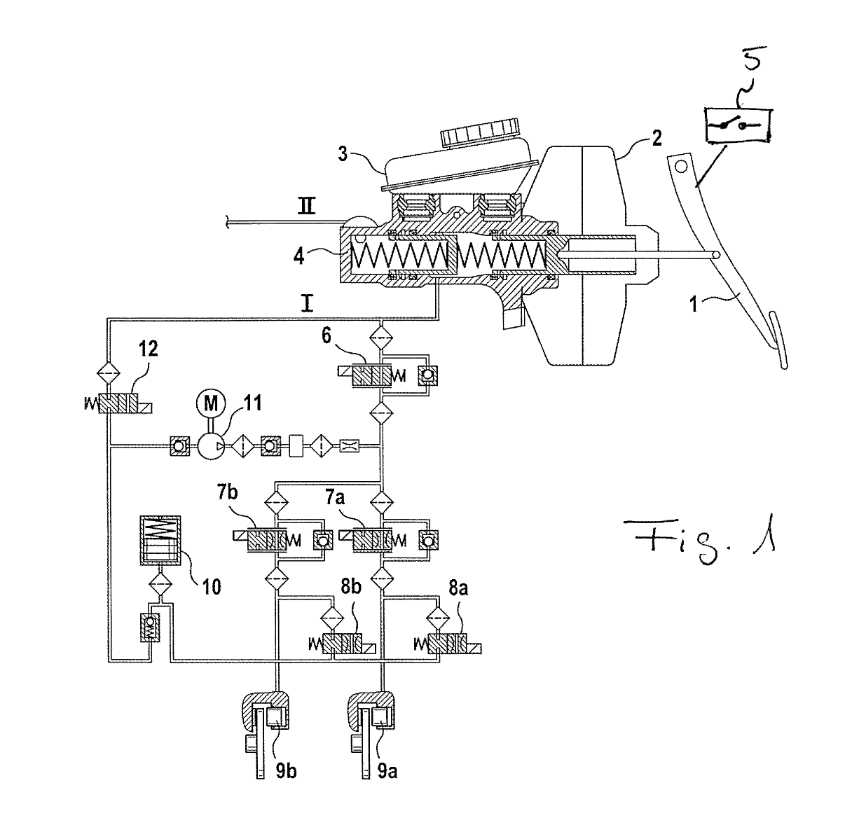

FIG. 1 illustrates an exemplary braking system of a motor vehicle and said exemplary braking system can be used to perform the method in accordance with the invention. The brake pedal 1 that can be actuated by the driver can be embodied with or without a power-assisted support. The braking force of the driver acts by way of a push rod, possibly superimposed by a power-assisted force that is built up by a low-pressure braking force booster 2, on a (tandem-) master brake cylinder 4 that in the non-activated state is connected to a non-pressurized brake fluid storage vessel. It is possible to establish by way of a brake light switch 5 whether the driver actuates the brake pedal. As an alternative, it is also possible to replace the brake light switch by a position sensor that is arranged by way of example on the master brake cylinder 4. The brake system comprises two brake circuits I, II that (in the case of a four-wheel motor vehicle) are each allocated two wheel brakes. Only the brake circuit I is described hereinunder, the other brake circuit II is expediently embodied in an identical manner. In principle, it is irrelevant for the method in accordance with the invention whether the brake circuits are separated, whether in other words for example in each case a front wheel brake and a rear wheel brake are combined in one brake circuit.

The master brake cylinder 4 is connected by way of brake lines to the wheel brakes 9a, 9b, wherein the first wheel brake 9a can be separated from the master brake cylinder 4 by virtue of closing a first inlet valve 7a, or the second wheel brake 9b can be separated from the master brake cylinder 4 by means of a second inlet valve 7b. The pressure in the first or second wheel brake can be reduced by opening the outlet valve 8a or 8b, in that brake fluid is diverted into a low pressure storage device 10. An electrically driven hydraulic pump 11 renders it possible to empty the low pressure storage device 10. Moreover, the braking system also comprises a solenoid valve 6 that can be controlled in an analog manner and is described as an isolation valve and is currentless open and is arranged between the outlet side of the hydraulic pump 11 and the master brake cylinder. The intake side of the hydraulic pump 11 is connected to the low pressure storage device 10 and can be connected to the master brake cylinder 4 by way of a solenoid valve that is currentless closed and is also known as an electronic switching valve.

In an expedient manner, wheel rotational speed sensors (not illustrated) are arranged on each wheel of the motor vehicle and said wheel rotational speed sensors are connected to an electronic control unit that is likewise not illustrated. If the rotational speed of a wheel greatly reduces during a braking operation, a brake slip control or an anti-block brake control can be performed, in that the corresponding inlet valve is closed and by opening the corresponding outlet valve the pressure in the wheel brake and consequently the braking force is reduced. The brake slip control can be performed by means of a method known per se, in which pressure build-up phases, pressure maintenance phases and pressure reduction phases are repeated in a cyclic manner. The electronic control unit that is known per se can also provide a yawing moment control, as is described for example in EP 0 792 229 B1, which is incorporated by reference. The control procedure of the braking system for a driver-independent pressure build-up is explained hereinunder.

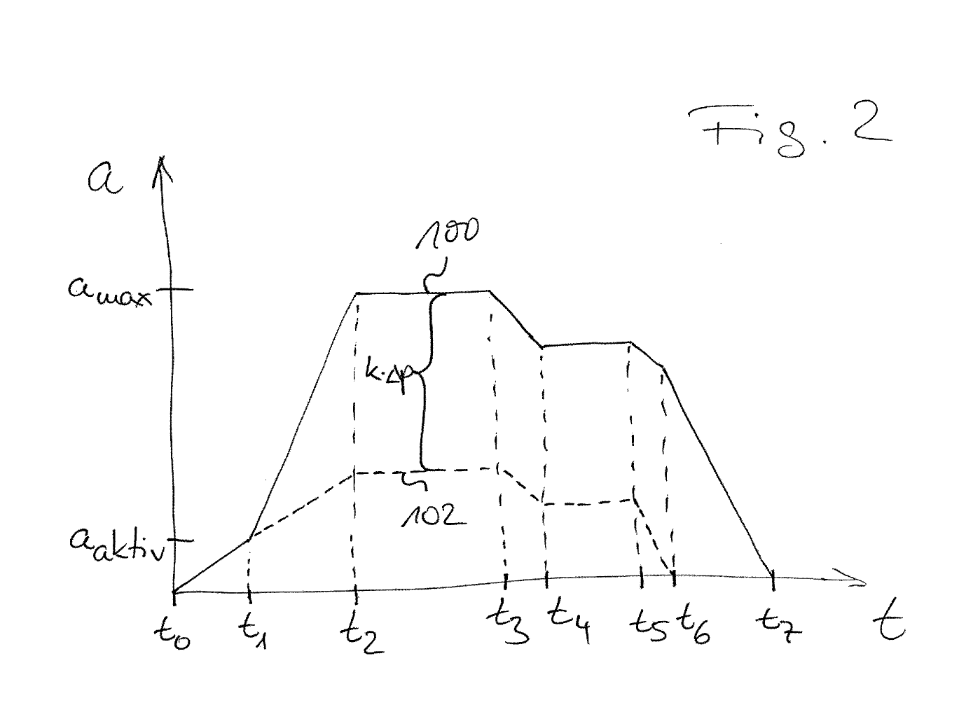

FIG. 2 illustrates a schematic view of an exemplary braking operation, wherein the deceleration a is plotted over time t. The continuous line 100 represents the vehicle deceleration, whereas the broken line 102 represents the deceleration that corresponds to the driver's intention.

If the change with respect to time of the signals from the wheel rotational speed sensors are observed, in particular from non-driven wheels, then it is possible to determine therefrom the prevailing acceleration or deceleration a of the vehicle. It is also possible in an expedient manner to perform a filtration procedure such as a low pass filtration procedure with suitable time constants and/or to form a mean value between the signals of different wheel rotational speed sensors. The driver actuates the brake at the point in time t₀, whereupon the vehicle deceleration increases in accordance with the pedal actuation. The beginning of the braking operation can be detected with reference to a change in the switched state of the brake light switch.

The actual deceleration a of the vehicle is interpreted as an indication of the driver's braking intention and is compared with the threshold value a_{active}. A dangerous situation is detected in an expedient manner if the actual deceleration exceeds the threshold value a_{active} within a predetermined period of time. As an alternative or in addition thereto, the gradient with respect to time or the amount of increase in the deceleration over time is compared with a predetermined threshold value. If the actual deceleration and/or the gradient with respect to time exceeds the respective threshold value, which in the case of the exemplary braking operation occurs at the point in time t₁, an additional pressure is built up in the wheel brakes, by virtue of the fact that the isolation valve 6 is closed, the switching valve 12 is opened and the pump is activated (while the inlet valves 7a, 7b are open and the outlet valves 8a, 8b are closed).

The activation of the pump leads to the pressure in the wheel brakes increasing and consequently the vehicle deceleration (line 100) increases more rapidly than corresponds to the driver's intention (line 102). In an expedient manner, the isolation valve 6 is controlled in an analog manner, by virtue of the fact that the switching procedure to control the valve applies a desired current according to a valve characteristic curve which is also described as an excess current control. The valve characteristic curve indicates the relationship between the valve current of a solenoid valve and the maximum pressure difference; it is determined in an expedient manner by virtue of performing a measurement of the valve or a calibration procedure at the end of the conveyor belt in the factory and storing the result in the electronic control unit. As soon as the pressure in the wheel brakes is greater than the pressure in the master brake cylinder by more than the desired pressure difference Δp, the isolation valve opens.

In a preferred embodiment of the invention, a fixed pressure difference Δp of by way of example 50 bar between the pressure in the master brake cylinder and the pressure in the wheel brakes is predetermined. The actual vehicle deceleration 100 is therefore Δp greater than the driver's intention 102. The constant k is produced by virtue of the design of the braking system. The fixed pressure difference is preferably selected so that on the one hand a minimum deceleration is ensured and on the other hand it is also ensured that the brake caliper in the wheel brakes is protected against being overloaded. In an alternative embodiment of the invention, it is also possible to provide that a desired pressure difference Δp is determined with reference to a predetermined booster characteristic, which, by way of example, indicates a relationship between the gradients of the brake pedal actuation with respect to time and the pressure difference that is to be set and which is stored in an expedient manner in the storage device of the electronic control unit. During the period of time between t₂ and t₃, the driver maintains a constant brake actuation and for this reason the vehicle deceleration also remains constant.

At the point in time t₃, the driver reduces the brake actuation without completely releasing the brake. The predetermined pressure difference is therefore not superimposed and the vehicle deceleration reduces according to the driver's intention. If the driver maintains a constant brake actuation at the point in time t₄, then the vehicle deceleration also remains constant (in this example it is assumed that the coefficient of friction is high and constant).

At the point in time t₅, the driver reduces the brake actuation further, wherein the vehicle deceleration correspondingly reduces. As soon as the brake pedal has been completely released, in other words at the point in time t₆, an end of the dangerous situation is detected and the hydraulic pump is deactivated. The switching valve 12 is closed and the isolation valve 6 slowly opened. For this purpose, the desired pressure difference or the current applied to the isolation valve 6 is reduced. This is preferably performed using a predetermined ramp. The pressure difference is completely eliminated at the point in time t₇.

In an expedient manner, the maximum occurring deceleration aₘₐₓ is determined during the entire braking operation at predetermined time intervals. The braking assistance is also preferably terminated if the actual vehicle deceleration is less than a predetermined fraction of the maximum occurring deceleration. If the braking operation is performed on a road surface whose coefficient of friction clearly reduces, a brake slip control can intervene. The outlet and inlet valves can be controlled in a manner known per se so as to exploit the prevailing coefficient of friction in an optimum manner. Even if the driver clearly reduces his braking intention, it is possible by comparing the instantaneous deceleration with the maximum occurring deceleration to detect that it is no longer necessary to provide any braking assistance. Furthermore, it is possible to provide that the braking assistance is terminated if it is detected that the vehicle is stationary or that the vehicle is moving at a predetermined low velocity.

By virtue of the fact that a driver-independent pressure build-up occurs, impact accidents are avoided that could otherwise occur as a result of a timid brake actuation by the driver who often does not fully exploit the prevailing coefficient of friction. By virtue of the fact that pressure builds up with the aid of an excess current control or an analog control of the isolation valve, further input from the driver is possible and the pressures are superimposed.

By virtue of using independent sensors, a reliable plausibility check is also ensured so that it is not necessary to provide a pressure sensor on the master brake cylinder in order to achieve a braking assistance in accordance with the invention.

1. A method for operating a braking system of a vehicle, said braking system comprising a master brake cylinder that can be actuated by the driver by a brake pedal, at least one driver-independent pressure source, at least one wheel brake that is allocated a wheel rotational speed sensor, and a brake actuation sensor, wherein a check is performed as to whether a dangerous situation is present and, in the event that a dangerous situation is detected, the at least one driver-independent pressure source is activated, wherein a dangerous situation is detected if a gradient with respect to time or a value of a measured deceleration exceeds a predetermined danger threshold value and a brake actuation is measured.

2. The method as claimed in claim 1, wherein the braking system comprises at least two, wheel brakes that are each allocated a wheel rotational speed sensor and the measured deceleration is determined from the signals from at least two wheel rotational speed sensors.

3. The method as claimed in claim 1, wherein a first deceleration is determined from signals of at least of a first wheel rotational speed sensor, and a second deceleration is determined from signals of at least a second sensor, wherein a dangerous situation is only detected if both the gradient with respect to time or the value of the first deceleration and also the gradient with respect to time or the value of the second deceleration exceeds the predetermined danger threshold value.

4. The method as claimed in claim 1, wherein a dangerous situation is only detected if the gradient with respect to time or the value of the measured deceleration exceeds the predetermined danger threshold value within a predetermined period of time following the detection of a brake actuation.

5. The method as claimed in claim 1, wherein in addition signals from a gas pedal are considered, wherein the braking system is preconditioned and/or a dangerous situation is only detected if a release rate of the gas pedal exceeds a predetermined panic threshold value and/or a period of time between the gas pedal being released and the brake pedal being actuated is less than a predetermined reaction threshold value.

6. The method as claimed in claim 2, wherein a first solenoid valve is arranged between the master brake cylinder and wheel brakes and said first solenoid valve is in particular currentless open, the driver-independent pressure source comprises an electric hydraulic pump that is connected on an outlet side to the wheel brake or wheel brakes and can be connected on an inlet side by way of a second solenoid valve, which is currentless closed, to the master brake cylinder, and a procedure of activating the driver-independent pressure source includes closing at least in part the first solenoid valve and opening the second solenoid valve.

7. The method as claimed in claim 6, wherein the first solenoid valve can be controlled in an analog manner in order to maintain a predetermined pressure difference between the master brake cylinder and the wheel brakes, wherein the predetermined pressure difference between the master brake cylinder and the wheel brakes is limited to a constant value.

8. The method as claimed in claim 7, wherein the current is adjusted by the first solenoid valve according to a characteristic curve that describes the relationship between the valve current and the pressure difference and is read out from a non-volatile storage device.

9. The method as claimed in claim 1, wherein the procedure of measuring the deceleration is repeated and an end of the dangerous situation is detected and the driver-independent pressure source is deactivated if the value of the measured deceleration or the amount of increase in the measured deceleration after a predetermined period of time following the detection of the dangerous situation is less than a predetermined deactivation threshold value.

10. The method as claimed in claim 1, wherein the procedure of measuring the deceleration is repeated, wherein an actual value of the deceleration is compared with a maximum value, wherein the actual value of the deceleration is stored as the new maximum value if the previous maximum value is less than the actual value of the deceleration, and an end of the dangerous situation is detected and the driver-independent pressure source is deactivated if the actual value of the deceleration is less than a predetermined fraction of the maximum value.

11. The method as claimed in claim 1, wherein an end of the dangerous situation is detected and the driver-independent pressure source is deactivated if at least one of the vehicle velocity is less than a predetermined stopping threshold value, an end of the brake actuation is measured and the driver-independent pressure source has been operated for longer than a predetermined maximum time period.

12. A braking system for a motor vehicle, said braking system comprising:
a master brake cylinder that is actuated by the driver by a brake pedal
a driver-independent pressure source,
at least one wheel brake that is allocated a wheel rotational speed sensor, and
a brake actuation sensor, and,
an electronic control unit that is connected to the brake actuation sensor and provides braking assistance in a dangerous situation but is not connected to a sensor for detecting the pressure in the master brake cylinder.

13. The brake system as claimed in claim 12, wherein the electronic control unit comprises a first solenoid valve which is arranged between the master brake cylinder and wheel brakes and is currentless open, an electric hydraulic pump that is connected on the outlet side to the wheel brake or wheel brakes, a second solenoid valve, by way of which the electric hydraulic pump can be connected on the inlet side to the master brake cylinder and which is currentless closed, and also a control circuit for the first solenoid valve and the second solenoid valve, wherein the control circuit for the first solenoid valve comprises means for controlling the current.

14. The braking system as claimed in claim 12, wherein the electronic control unit comprises a computing unit that performs a method for operating the braking system of a vehicle, wherein a check is performed as to whether a dangerous situation is present and, in the event that a dangerous situation is detected, the driver-independent pressure source is activated, wherein a dangerous situation is detected if a gradient with respect to time or a value of a measured deceleration exceeds a predetermined danger threshold value and a brake actuation is measured, wherein program code for performing the method is stored in a non-volatile storage device.

15. The braking system as claimed in claim 12, wherein the electronic control unit comprises an interface for a vehicle data bus and is connected to an engine control unit.

16. The method as claimed in claim 1, the brake actuation sensor is a brake light switch.

17. The method as claimed in claim 2, the at least two wheel rotational speed sensors are arranged on the front axle.

18. The method as claimed in claim 2, wherein a first deceleration is determined from signals of at least of a first wheel rotational speed sensor, and a second deceleration is determined from signals of at least a second sensor, wherein a dangerous situation is only detected if both the gradient with respect to time or the value of the first deceleration and also the gradient with respect to time or the value of the second deceleration exceeds the predetermined danger threshold value.

19. The method as claimed in claim 7, wherein the predetermined pressure difference between the master brake cylinder and the wheel brakes is between 30 and 60 bar.

20. The braking system as claimed in claim 12, wherein the driver-independent pressure source is an electric hydraulic pump.
